(19) United States
(12) Patent Application Publication
(10) Pub. No.: US 2012/0084479 A1
(43) Pub. Date: Apr. 5, 2012

(54) Modular Digital Presentation Switcher

(76) Inventors: Phillip A. HALE, Brea, CA (US); Tamer ElSawah, Chino Hills, CA (US)

(21) Appl. No.: 13/247,853

(22) Filed: Sep. 28, 2011

Related U.S. Application Data
(60) Provisional application No. 61/388,772, filed on Oct. 1, 2010.

(51) Int. Cl. G06F 13/36

(52) U.S. Cl. 710/301; 710/104

(57) ABSTRACT

A modular digital presentation switcher is a device that can convert different kinds of incoming multimedia signals into an outgoing signal in an analog and digital format. The device retrieves the incoming multimedia signals through input modules. Each of the input modules is capable of retrieving a unique signal such as composite video or S-video, VGA, and DVI-D. The device sends the outgoing signal through output modules, which are connected to the display device and the audio amplifier. A communication bus allows the input modules and the output modules to communicate with each other so that the device can cater and format the outgoing signal for the display device and the audio amplifier. An HDMI digital signal bus allows the input modules to send the outgoing signal in HDMI digital format to the output modules. A user interface module allows the user to access the functions of the device.

The current application claims a priority to the U.S. Provisional Patent application Ser. No. 61/388,772 filed on Oct. 1, 2010.

### FIELD OF THE INVENTION

The present invention generally relates to a presentation device capable of enhancing and converting different kinds of input signals, such as composite video or separate video, into a common output signal format such as HDMI, VGA, and analog stereo audio.

### BACKGROUND OF THE INVENTION

Audio, video, and teleconference equipment has advanced to include new technologies and signal formats. Digital formats, such as HDMI, DVI-D, and DisplayPort signals, are becoming more common in presentation facilities. Designers of these types of facilities are forced to discard older display systems and equipment to support these new technologies. With a modular design, the present invention accepts older analog signal formats in addition to newer digital signal formats, enhances the signal where necessary, and converts the signal to a digital format in the format of the display device. Audio output is provided via speaker level or as a line level output for the convenience of the system designer.

### BRIEF DESCRIPTION OF THE DRAWINGS

FIG. 1 is a simplified diagram depicting the major electronic connections in the present invention.

FIG. 2 is an exploded view of the internal components shown from the back of the present invention.

FIG. 3 is an exploded view of the internal components shown from the front of the present invention.

FIG. 4 is a back perspective view of the internal components being attached to each other.

FIG. 5 is a front perspective view of the internal components being attached to each other.

FIG. 6 is a back perspective view of the present invention with the enclosure.

FIG. 7 is a front perspective view of the present invention with the enclosure.

### DETAIL DESCRIPTIONS OF THE INVENTION

All illustrations of the drawings are for the purpose of describing selected versions of the present invention and are not intended to limit the scope of the present invention.

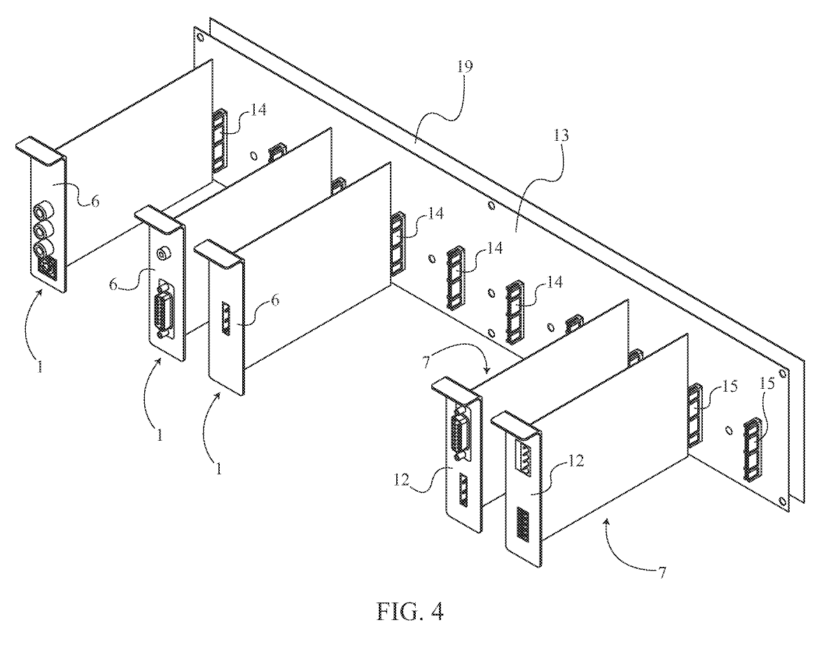

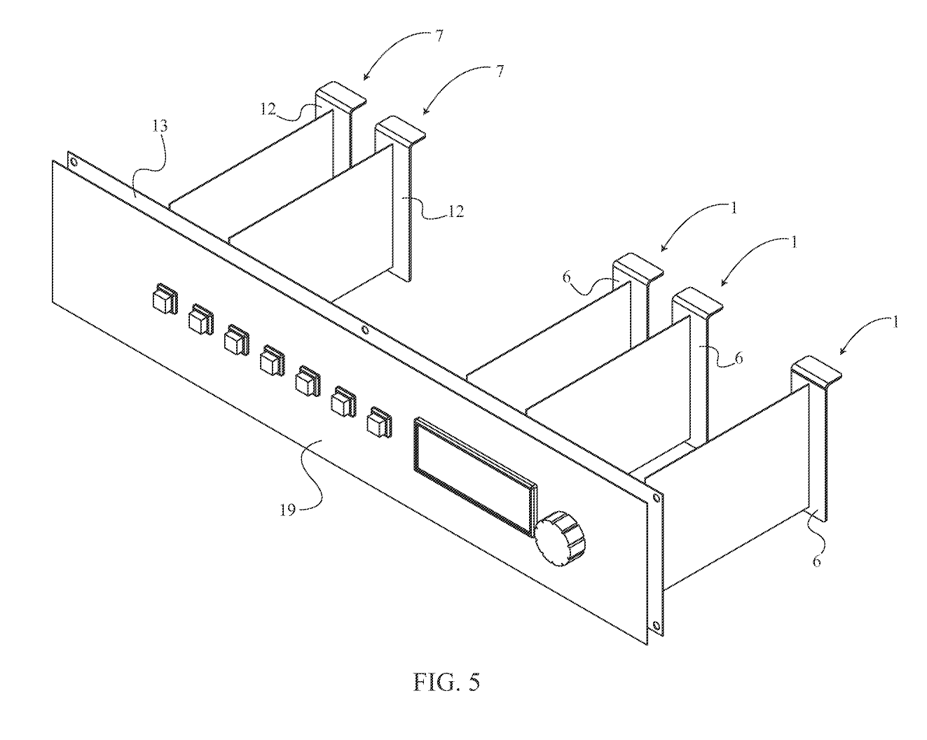

As can be seen in FIGS. 4, 5, 6 and 7, the present invention is a modular digital presentation switcher, which allows a user to switch between different kinds of input signals for an audiovisual presentation. The present invention can be used to convert incoming signals from a variety of digital and analog source devices and provides a single outgoing signal. The modular digital presentation switcher comprises a plurality of input board assemblies 1, an plurality of output modules 7, a common bus 13, a user interface assembly 19, and an enclosure 21. Each of the plurality of input board assemblies 1 is a modular card that is designed to receive a specific kind of incoming signal such as high-definition multimedia interface (HDMI), video graphics array (VGA), composite video, separate video (S-video), digital-visual interface (DVI), and DisplayPort. Each of the plurality of output modules 7 is also a modular card that is used to convey the outgoing signal in an HDMI digital format to either a primary display device or an audio amplification system. Both the plurality of input board assemblies 1 and the plurality of output modules 7 are physically attached to the common bus 13, which allows the plurality of input board assemblies 1 and the plurality of output modules 7 to communicate with each other. The user interface assembly 19 is also attached to the common bus 13 and allows the user access to present invention via serial or Ethernet connections. The enclosure 21 is a casing that used to house the plurality of input board assemblies 1, the plurality of output modules 7, the common bus 13, and the user interface assembly 19.

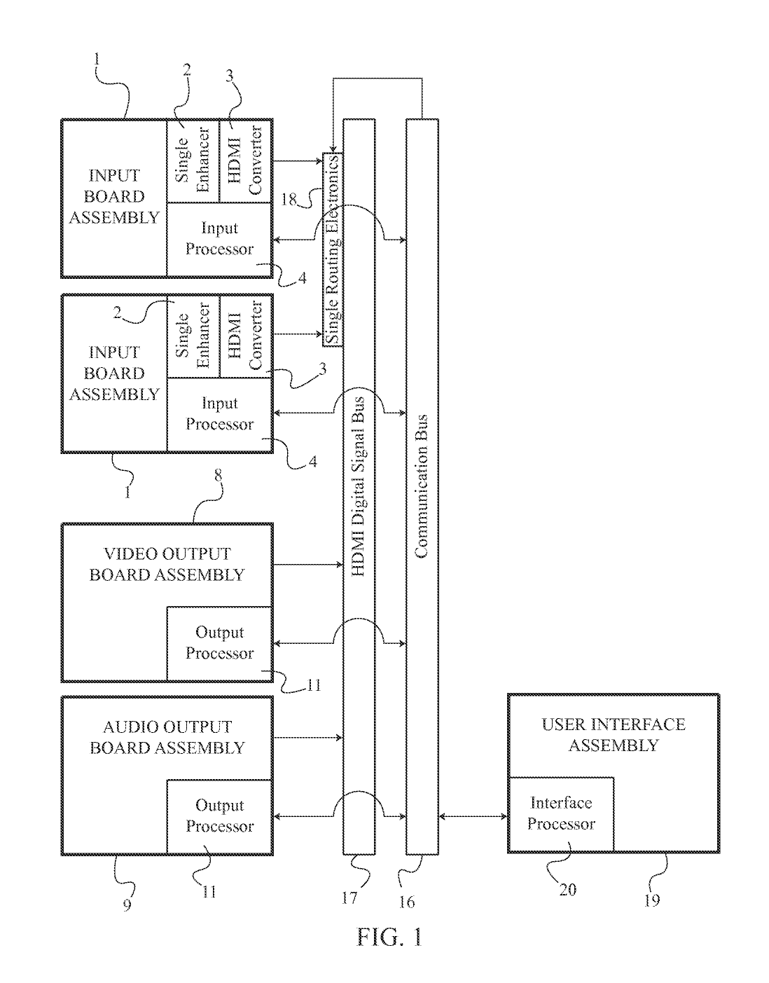

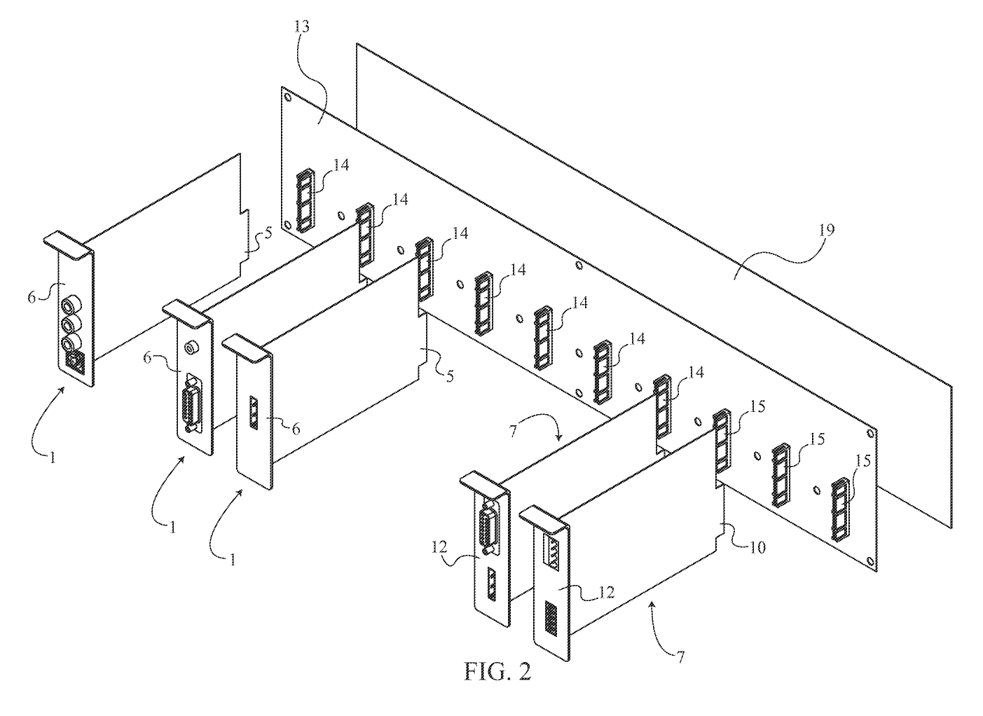

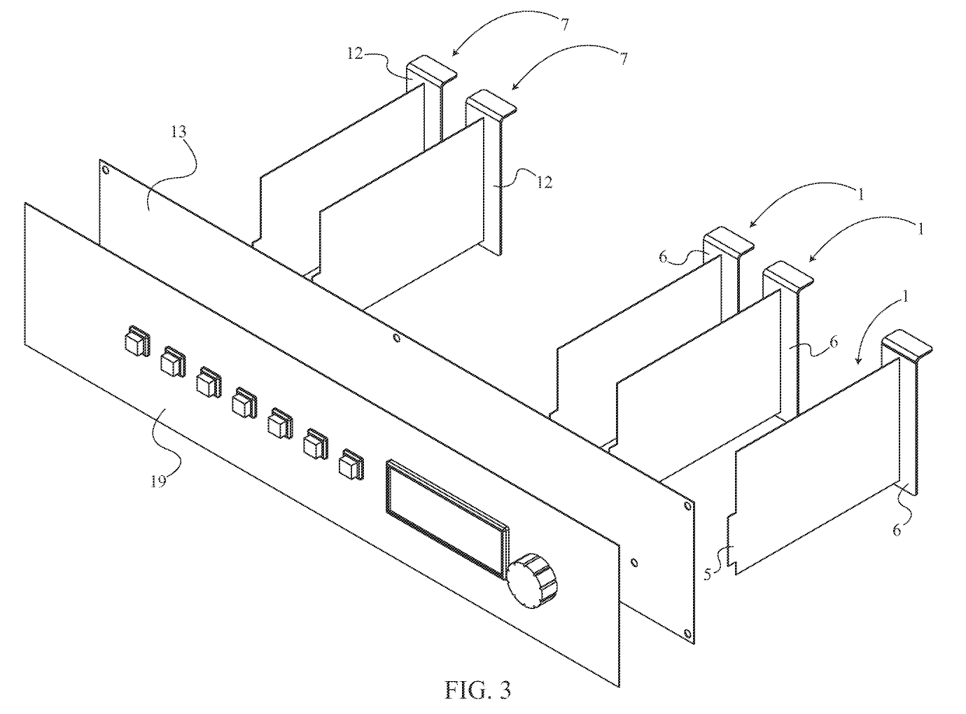

The plurality of input board assemblies 1 is able to process and enhance an incoming signal and is able to convert that incoming signal into an HDMI digital format. Each of the plurality of input board assemblies 1 comprises a signal enhancer 2, an HDMI converter 3, an input processor 4, an input connector 5, and an incoming signal port 6. The signal enhancer 2, the HDMI converter 3, the input processor 4 are shown in FIG. 1, and the input connector 5 and the incoming signal port 6 are shown in FIGS. 2 and 3. The incoming signal port 6 allows each of the plurality of input board assemblies 1 to physically connect to an input device such as a document camera or a computer. Each of the incoming signal ports 6 for each of the plurality of input board assemblies 1 is designed and shaped to retrieve a different kind of incoming signal. For example, one input board assembly can have an incoming signal port 6 designed and shaped to retrieve signals in VGA, and another input board assembly can have an incoming signal port 6 designed and shaped to retrieve signals in S-video. The input processor 4 allows each of the plurality of input board assemblies 1 to analyze the incoming signal, to instruct the other components of the input board assembly, and to communicate with the other components of the present invention. The input processor 4 is electronically connected on each of the plurality of input board assemblies 1 to the incoming signal port 6. The signal enhancer 2 allows each of the plurality of input board assemblies 1 to modify the incoming signal to achieve the resolution that is preferred by the primary display device and the audio amplification system. The HDMI converter 3 allows each of the plurality of input board assemblies 1 to translate the incoming signal into a HDMI digital format and create an outgoing signal. For example, the signal enhancer 2 and the HDMI converter 3 would work in combination to scale up an incoming signal with lower resolution, such as composite video or S-video, and convert the incoming signal with lower resolution from analog to digital. Both the signal enhancer 2 and the HDMI converter 3 are electronically connected to the input processor 4 and to each other. The input connector 5 allows each of the plurality of input board assemblies 1 to physically attach to common bus 13. The input connector 5 is electronically connected to both the input processor 4 and the HDMI converter 3.

The plurality of output modules 7 is able to send an outgoing signal to the primary display device and the audio amplification system. The plurality of output modules 7 comprises a video output board assembly 8 and an audio output board assembly 9, which are illustrated in FIG. 1. The video output board assembly 8 allows the present invention to send the visual portion of the outgoing signal, and the audio output board assembly 9 allows the present invention to send the aural portion of the outgoing signal. The video output board assembly 8 provides the user with the visual portion of the outgoing signal in HDMI digital format, but, in the preferred embodiment of the present invention, the video output board assembly 8 also provides an analog VGA copy of the visual portion of the outgoing signal. The audio output board assembly 9 provides the user with the aural portion of the outgoing signal either at 70V/100V speaker level for commercial-grade ceiling speakers or at line level for audio mixers, recording devices, or video conference systems. The video output board assembly 8 and the audio output board assembly 9 each comprise an output connector 10, an output processor 11, and an outgoing signal port 12. The output processor 11 is shown in FIG. 1, and the output connector 10 and the outgoing signal port 12 are shown in FIGS. 2 and 3. The output connector 10 is used to physically attach the video output board assembly 10 and the audio output board assembly 11 to the common bus 13. The output connector 10 is electronically connected to the output processor 11 and the outgoing signal port 12. The output processor 11 allows the video output board assembly 8 and the audio output board assembly 9 to communicate the resolution preferred by the primary display device to the plurality of input board assemblies 1. The output processor 11 must also be electronically connected to the outgoing signal port 12 because the outgoing signal port 12 is designed to physically connect to the primary display device or to the audio amplification system. The output processor 11 would not be able to determine the resolution preferred by the primary display device without being electronically connected to the outgoing signal port 12. In addition, the output processor 11 allows the video output board assembly 8 to instruct the other components of the video output board assembly 8 and allows the audio output board assembly 9 to instruct the other components of the audio output board assembly 9. The outgoing signal port 12 of the video output board assembly 8 is designed and shaped to accommodate an HDMI digital signal and, in the preferred embodiment, an VGA copy of the HDMI digital signal. The outgoing signal port 12 of the audio output board assembly 9 is designed and shaped to accommodate either a 70V/100V speaker level or a line level.

The common bus 13 is by used by the plurality of input boards assemblies and the plurality of output modules 7 as a means to relay signals and to communicate with each other. The common bus 13 comprises a plurality of input slots 14, a plurality of output slots 15, a communication bus 16, an HDMI digital signal bus 17, and a set of signal routing electronics 18. The communication bus 16, the HDMI digital signal bus 17, and the set of signal routing electronics 18 is shown in FIG. 1, and the plurality of input slots 14 and the plurality of output slots 15 is shown in FIGS. 2 and 3. The plurality of input slots 14 and the plurality of output slots 15 allow the plurality of input board assemblies 1 and the plurality of output modules 7 to physically connect with the common bus 13. The plurality of input slots 14 and the plurality of output slots 15 are positioned along the common bus 13. As can be seen in FIG. 4, the plurality of input board assemblies 1 is physically connected to the common bus 13 by inserting the input connector 5 into one of the plurality of input slots 14. Once the input connector 5 of an input board assembly is inserted into an input slot, the input processor 4 of that input board assembly is electronically connected to the communication bus 16, and the HDMI converter 3 of that input board assembly is electronically connected to the HDMI digital signal bus 17 through the set of signal routing electronics 18. As can be seen in FIG. 4, the plurality of output modules 7 is also physically connected to the common bus 13 by inserting the output connector 10 of the video output board assembly 8 into one of the plurality of output slots 15 and by inserting the output connector 10 of the audio output board assembly 9 into another output slots 15. Once the output connector 10 of the video output board assembly 8 is inserted into one of the plurality of output slots 15, the output processor 11 of the video output board assembly 8 is electronically connected to the communication bus 16, and the outgoing signal port 12 of the video output board assembly 8 is electronically connected to the HDMI digital signal bus 17. Furthermore, once the output connector 10 of the audio output board assembly 9 is inserted in another output slot, the output processor 11 of the audio output board assembly 9 is electronically connected to the communication bus 16, and the outgoing signal port 12 of the audio output board assembly 9 is electronically connected to the HDMI digital signal bus 17. The communication bus 16 and the HDMI digital signal bus 17 serve two different functions and are positioned to be electrically parallel to each other on the common bus 13. The communication bus 16 allows the input processor 4 of each of the plurality of input board assemblies 1, the output processor 11 of the video output board assembly 8, and the output processor 11 of the audio output board assembly 9 to communicate with each other. The HDMI digital signal bus 17 provides the outgoing signal with the means to traverse to the video output board assembly 8 and the audio output board assembly 9. The set of signal routing electronics 18 acts as a filter for the HDMI digital signal bus 17 and allows only outgoing signals from an input board assembly, which is specified by the user, to pass into the HDMI digital signal bus 17. The set of signal routing electronics 18 is also electronically connected to the communication bus 16.

The present invention uses a process to properly convert an incoming signal from an input device into an outgoing signal for the primary display device and the audio amplification system. FIG. 1 can be used to follow the process used by the present invention. The process begins by allowing each of the plurality of input board assemblies 1 to simultaneously access their incoming signal through their incoming signal port 6. The input processor 4 of each of the plurality of input board assemblies 1 corresponds with the output processor 11 of the video output board assembly 8 and the output processor 11 of the audio output board assembly 9 along the communication bus 16 in order to determine the best resolution for the primary display device and the audio amplification system. The input processor 4 will then instruct the signal enhancer 2 to modify the incoming signal according to the best resolution. Subsequently, the HDMI converter 3 will change the modified incoming signal into HDMI signal format and create an outgoing signal. The outgoing signal of each of the plurality of input board assemblies 1 is sent to the set of signal routing electronics 18. The set of signal routing electronics 18 determines which of the outgoing signals is sent to the plurality of output modules 7 with a user command relayed by the user interface assembly 19 through the communication bus 16. In the preferred embodiment, the user interface assembly 19 can be a front panel button press, serial port communication, or an Ethernet command. The user interface assembly 19 comprises an interface processor 20, which is used to coordinate the other components of the user interface assembly 19 and to communicate with the plurality of input board assemblies 1, the plurality of output modules 7, and the set of signal routing electronics 18. The user interface assembly 19 is physically connected to the common bus 13, which allows the interface processor 20 to be electronically connected to the communication bus 16. When the user interface assembly 19 retrieves the user command, then the interface processor 20 will relay the user command to the set of signal routing electronics 18. The user command is a choice that is made by the user on which of the plurality of input board assemblies 1 should be able to send their outgoing signal to the plurality of output modules 7. Finally, the chosen outgoing signal is sent to the plurality of output modules 7 through the HDMI digital signal bus 17, which allows the outgoing signal port 12 of the video output board assembly 8 to transmit the visual portion of the outgoing signal to the primary display device and allows the outgoing signal port 12 of the audio output board assembly 9 to transmit the aural portion of the outgoing signal to the audio amplification system.

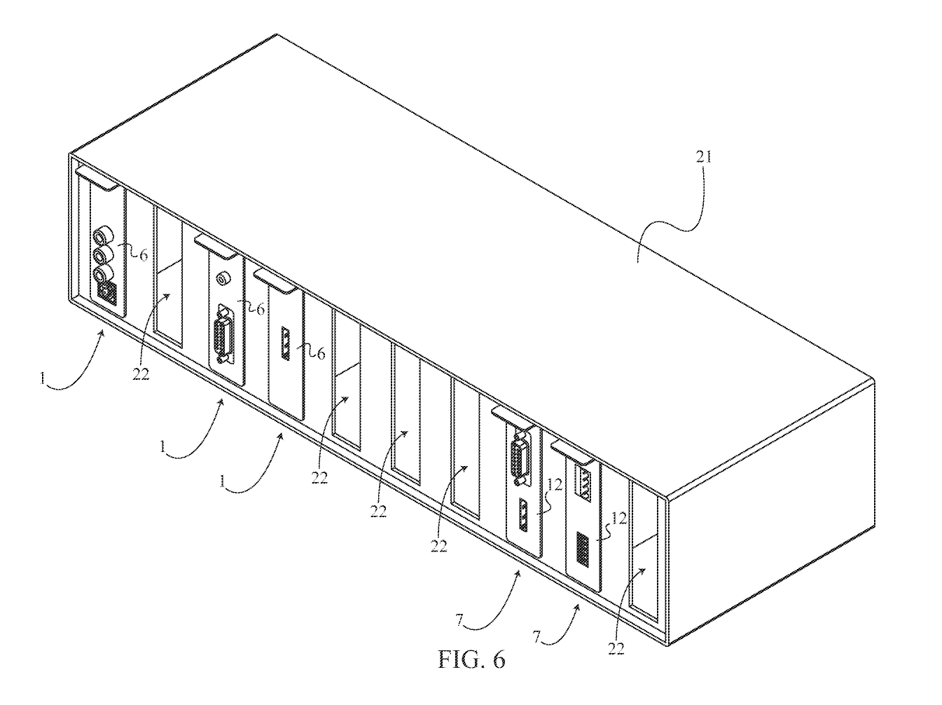

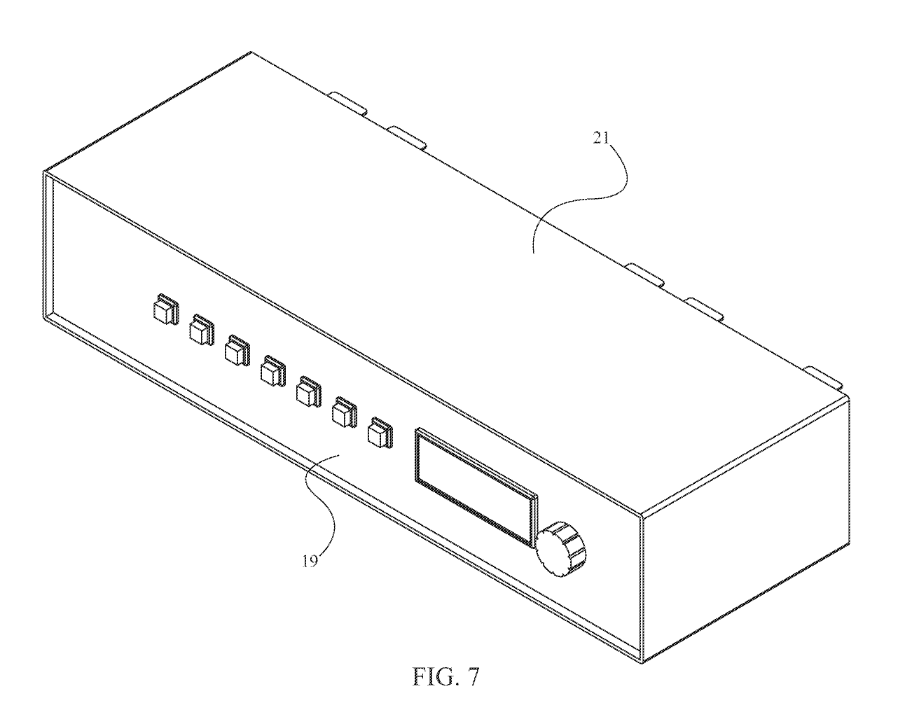

Finally, the present invention uses an enclosure 21 to protect and encapsulate its other components. The enclosure can only be seen on FIGS. 6 and 7. The common bus 13 is mounted within enclosure 21, and the user interface assembly 19 is positioned on the enclosure 21 in such a way that the user interface assembly 19 is easily accessible to the user. The enclosure 21 comprises a plurality of board slots 22, which allow the plurality of input board assemblies 1, the video output board assembly 8, and the audio output board assembly 9 to traverse through the enclosure 21 and physically connect to the common bus 13.

Although the invention has been explained in relation to its preferred embodiment, it is to be understood that many other possible modifications and variations can be made without departing from the spirit and scope of the invention as hereinafter claimed.

What is claimed is:

1. A modular digital presentation switcher comprises,
an enclosure;
a plurality of input board assemblies;
a common bus;
an plurality of output modules;
an user interface assembly;
said enclosure comprises a plurality of board slots;
each of said plurality of input board assemblies comprises a signal enhancer, an HDMI converter, an input processor, an input connector, and an incoming signal port;
said common bus comprises a plurality of input slots, a plurality of output slots, a communication bus, an HDMI digital signal bus, and a set of signal routing electronics;
said plurality of output modules comprises a video output board assembly and an audio output board assembly;
said user interface assembly comprises an interface processor; and
said video output board assembly and said audio output board assembly each comprise an output connector, an output processor, and an outgoing signal port.

2. The modular digital presentation switcher as claimed in claim 1 comprises,
said plurality of input board assemblies being electronically connected to said plurality of output modules through said common bus;
said plurality of input board assemblies and said plurality of output modules being electronically connected to said user interface assembly; and
said plurality of input board assemblies, said common bus, said plurality of output modules, and said user interface assembly being housed within said enclosure.

3. The modular digital presentation switcher as claimed in claim 1 comprises,
said incoming signal port being positioned opposite of said input connector on each of said plurality of input board assemblies;
said incoming signal port being electronically connected to said input processor;
said input processor being electronically connected to said signal enhancer and to said HDMI converter;
said signal enhancer being electronically connected to said HDMI converter; and
said input connector being electronically connected to said input processor and said HDMI converter.

4. The modular digital presentation switcher as claimed in claim 1 comprises,
said outgoing signal port of said video output board assembly being positioned opposite of said output connector of said video output board assembly;
said outgoing signal port of said audio output board assembly being positioned opposite of said output connector of said audio output board assembly;
said outgoing signal port being electronically connected to said output connector; and
said output processor being electronically connected to said output connector and said outgoing signal port.

5. The modular digital presentation switcher as claimed in claim 1 comprises,
said plurality of input slots and said plurality of output slots being positioned adjacent to each other along said common bus;
said plurality of input slots and said plurality of output slots being electronically connected to said communication bus;
said plurality of input slots and said plurality of output slots being electronically connected to said HDMI digital signal bus; and
said communication bus and said HDMI digital signal bus being electronically parallel to each other.

6. The modular digital presentation switcher as claimed in claim 1 comprises,
said input connector of each of said plurality of input board assemblies being inserted into said plurality of input slots; and
said output connector of said video output board assembly and said output connector of said audio output board assembly being inserted into said plurality of output slots.

7. The modular digital presentation switcher as claimed in claim 6 comprises,
said input processor of each of said plurality of input board assemblies being electronically connected to said communication bus;
said output processor of said video output board assembly and said output processor of said audio output board assembly being electronically connected to said communication bus;
said interface processor being electronically connected to said communication bus; and
said set of signal routing electronics being electronically connected to said communication bus.

8. The modular digital presentation switcher as claimed in claim 6 comprises,
said HDMI converter of each of said plurality of input board assemblies being electronically connected to said HDMI digital signal bus through said set of signal routing electronics;
said outgoing signal port of said video output board assembly being electronically connected to said HDMI digital signal bus; and
said outgoing signal port of said audio output board assembly being electronically connected to said HDMI digital signal bus.

9. The modular digital presentation switcher as claimed in claim 1 comprises,
said plurality of board slots being traversed through by each of said plurality of input board assemblies, said video output board assembly, and said audio output board assembly; and
said common bus being mounted within said enclosure.

10. A modular digital presentation switcher comprises,
an enclosure;
a plurality of input board assemblies;
a common bus;
an plurality of output modules;
an user interface assembly;
said enclosure comprises a plurality of board slots;
each of said plurality of input board assemblies comprises a signal enhancer, an HDMI converter, an input processor, an input connector, and an incoming signal port;
said common bus comprises a plurality of input slots, a plurality of output slots, a communication bus, an HDMI digital signal bus, and a set of signal routing electronics;
said plurality of output modules comprises a video output board assembly and an audio output board assembly;
said user interface assembly comprises an interface processor;
said video output board assembly and said audio output board assembly each comprise an output connector, an output processor, and an outgoing signal port;
said plurality of input board assemblies being electronically connected to said plurality of output modules through said common bus;
said plurality of input board assemblies and said plurality of output modules being electronically connected to said user interface assembly; and
said plurality of input board assemblies, said common bus, said plurality of output modules, and said user interface assembly being housed within said enclosure.

11. The modular digital presentation switcher as claimed in claim 10 comprises,
said incoming signal port being positioned opposite of said input connector on each of said plurality of input board assemblies;
said incoming signal port being electronically connected to said input processor;
said input processor being electronically connected to said signal enhancer and to said HDMI converter;
said signal enhancer being electronically connected to said HDMI converter;
said input connector being electronically connected to said input processor and said HDMI converter;
said outgoing signal port of said video output board assembly being positioned opposite of said output connector of said video output board assembly;
said outgoing signal port of said audio output board assembly being positioned opposite of said output connector of said audio output board assembly;
said outgoing signal port being electronically connected to said output connector; and
said output processor being electronically connected to said output connector and said outgoing signal port.

12. The modular digital presentation switcher as claimed in claim 10 comprises,
said plurality of input slots and said plurality of output slots being positioned adjacent to each other along said common bus;
said plurality of input slots and said plurality of output slots being electronically connected to said communication bus;
said plurality of input slots and said plurality of output slots being electronically connected to said HDMI digital signal bus;
said communication bus and said HDMI digital signal bus being electronically parallel to each other;
said input connector of each of said plurality of input board assemblies being inserted into said plurality of input slots; and
said output connector of said video output board assembly and said output connector of said audio output board assembly being inserted into said plurality of output slots.

13. The modular digital presentation switcher as claimed in claim 12 comprises,
said input processor of each of said plurality of input board assemblies being electronically connected to said communication bus;
said output processor of said video output board assembly and said output processor of said audio output board assembly being electronically connected to said communication bus;
said interface processor being electronically connected to said communication bus;
said set of signal routing electronics being electronically connected to said communication bus;
said HDMI converter of each of said plurality of input board assemblies being electronically connected to said HDMI digital signal bus through said set of signal routing electronics;
said outgoing signal port of said video output board assembly being electronically connected to said HDMI digital signal bus; and
said outgoing signal port of said audio output board assembly being electronically connected to said HDMI digital signal bus.

14. The modular digital presentation switcher as claimed in claim 10 comprises,
said plurality of board slots being traversed through by each of said plurality of input board assemblies, said video output board assembly, and said audio output board assembly; and
said common bus being mounted within said enclosure.

15. A modular digital presentation switcher comprises,
an enclosure;
a plurality of input board assemblies;
a common bus;
an plurality of output modules;
an user interface assembly;
said enclosure comprises a plurality of board slots;
each of said plurality of input board assemblies comprises a signal enhancer, an HDMI converter, an input processor, an input connector, and an incoming signal port;
said common bus comprises a plurality of input slots, a plurality of output slots, a communication bus, an HDMI digital signal bus, and a set of signal routing electronics;
said plurality of output modules comprises a video output board assembly and an audio output board assembly;
said user interface assembly comprises an interface processor;
said video output board assembly and said audio output board assembly each comprise an output connector, an output processor, and an outgoing signal port;
said plurality of input board assemblies being electronically connected to said plurality of output modules through said common bus;
said plurality of input board assemblies and said plurality of output modules being electronically connected to said user interface assembly;
said plurality of input board assemblies, said common bus, said plurality of output modules, and said user interface assembly being housed within said enclosure;
said incoming signal port being positioned opposite of said input connector on each of said plurality of input board assemblies;
said incoming signal port being electronically connected to said input processor;
said input processor being electronically connected to said signal enhancer and to said HDMI converter;
said signal enhancer being electronically connected to said HDMI converter;
said input connector being electronically connected to said input processor and said HDMI converter;
said outgoing signal port of said video output board assembly being positioned opposite of said output connector of said video output board assembly;
said outgoing signal port of said audio output board assembly being positioned opposite of said output connector of said audio output board assembly;
said outgoing signal port being electronically connected to said output connector;
said output processor being electronically connected to said output connector and said outgoing signal port;
said plurality of input slots and said plurality of output slots being positioned adjacent to each other along said common bus;
said plurality of input slots and said plurality of output slots being electronically connected to said communication bus;
said plurality of input slots and said plurality of output slots being electronically connected to said HDMI digital signal bus; and
said communication bus and said HDMI digital signal bus being electronically parallel to each other.

16. The modular digital presentation switcher as claimed in claim 15 comprises,
said input connector of each of said plurality of input board assemblies being inserted into said plurality of input slots;
said output connector of said video output board assembly and said output connector of said audio output board assembly being inserted into said plurality of output slots;
said input processor of each of said plurality of input board assemblies being electronically connected to said communication bus;
said output processor of said video output board assembly and said output processor of said audio output board assembly being electronically connected to said communication bus;
said interface processor being electronically connected to said communication bus;
said set of signal routing electronics being electronically connected to said communication bus;
said HDMI converter of each of said plurality of input board assemblies being electronically connected to said HDMI digital signal bus through said set of signal routing electronics;
said outgoing signal port of said video output board assembly being electronically connected to said HDMI digital signal bus; and
said outgoing signal port of said audio output board assembly being electronically connected to said HDMI digital signal bus.

17. The modular digital presentation switcher as claimed in claim 15 comprises,
said plurality of board slots being traversed through by each of said plurality of input board assemblies, said video output board assembly, and said audio output board assembly; and
said common bus being mounted within said enclosure.
